(19) United States
(12) Patent Application Publication
(10) Pub. No.: US 2015/0107625 A1
(43) Pub. Date: Apr. 23, 2015

(54) DIESEL ENGINE CLEANING SYSTEM AND METHOD

(71) Applicant: BG INTELLECTUALS, INC., WICHITA, KS (US)

(72) Inventors: MICHAEL J. ERWIN, AUGUSTA, KS (US); DAVID A. TENPENNY, OSKALOOSA, KS (US); CASEY BIENIEK, WICHITA, KS (US); JEFFREY BRUMMETT, WICHITA, KS (US)

(21) Appl. No.: 14/512,803

(22) Filed: Oct. 13, 2014

Related U.S. Application Data
(60) Provisional application No. 61/892,762, filed on Oct. 18, 2013.

(51) Int. Cl. F02B 77/04

(52) U.S. Cl. CPC F02B 77/04; F02B 2077/045
USPC 134/18; 134/104.2; 134/105

(57) ABSTRACT

The present invention discloses a system and method for removing soot and residue deposits from inside a diesel engine. The system provides a portable way of storing and heating a cleaning solution and passing the heated cleaning solution through an adaptor to an air intake of an operating diesel engine. The heated cleaning solution is withdrawn from the cleaning system by the vacuum pressure of the operating diesel engine and by air pressure applied to a storage tank containing the cleaning solution.

### CROSS-REFERENCE TO RELATED APPLICATIONS

This application claims priority to U.S. Provisional Patent Application Ser. No. 61/892,762, filed Oct. 18, 2014, having the same title, the disclosure of which is hereby incorporated herein in its entirety by reference.

### TECHNICAL FIELD

The present invention generally relates to a system and method for cleaning soot and oil deposits present in a diesel engine. More specifically, a portable system is provided through which a cleaning solution is heated and controllably directed into an air inlet region of a diesel engine for removing build-up throughout the engine.

### BACKGROUND OF THE INVENTION

At the heart of a modern day engine is the combustion process, where a fuel and compressed air mix and ignite to burn in order to generate thermal energy that is harnessed for mechanical purposes. In the case of an engine for a vehicle, the thermal energy generated can be converted to provide acceleration to a vehicle. Unfortunately, the combustion processes of modern internal combustion engines are not one-hundred percent efficient, thereby resulting in some fuel or by-products of combustion remaining in the engine. Due to the operating temperatures of the engine, these by-products can create undesirable build-up in parts of the engine, thereby affecting performance and efficiency.

Modern day diesel engines can generate soot and oil residue as part of the combustion process. These deposits can occur as a result of an incomplete combustion process. That is, since not all of the fuel injected is burned in the combustion process, heated liquid fuel droplets and soot are deposited at various points throughout the engine. These deposits build up over time and result in a clogging of the diesel particulate filter, reducing the amount of airflow to the engine, which then reduces the overall efficiency and performance of the engine. Furthermore, these deposits can also restrict turbo boost pressure and catalytic system operation and efficiency. Where diesel engines are utilized in automobiles or other vehicles, this reduced efficiency can result in increased operating costs to the vehicle owner.

To reduce the amount of build-up of soot and oil residue in diesel engines, a combination of sufficient heat and exhaust volume is necessary. This can often be achieved in vehicles that operate at high speeds, but does not often occur in vehicles that operate at lower speeds, such as in cities, where speeds are lower and more time is spent at idle, such as when in congested and slow moving traffic.

Presently, to combat the build-up of deposits over time in diesel fuel engines, vehicles will require periodic service where the diesel particulate filter is removed, placed in an oven, and baked at approximately 1300 degrees Fahrenheit. Baking the filter causes the soot particles to burn and form an ash that can then be blown out of the filter. This process, although proven, is costly and timely to complete.

Therefore, it is necessary to identify an alternative way to eliminate the soot and oil residues that build up in diesel engines in a way that is less costly and requires less time to perform.

### SUMMARY

Embodiments of the invention are defined by the claims below, not this summary. This summary is being provided to meet statutory requirements. A high-level overview of various aspects of the invention are provided here for that reason, to provide an overview of the disclosure, and to introduce a selection of concepts that are further described in the detailed description section below. This summary is not intended to identify key features or essential features of the claimed subject matter, nor is it intended to be used as an aid in isolation to determine the scope of the claimed subject matter.

The present invention discloses a cleaning system and method that provide a way of completing necessary maintenance for a diesel engine in order to remove soot and oil residue. The cleaning system and method provides a thorough chemical flush directly into the air intake of a diesel engine to soften and dissolve the soot and oil deposits.

In an embodiment of the present invention, a portable cleaning system for removing deposits from a diesel engine is disclosed. The portable cleaning system comprises a storage cart, a cleaning solution intake, a storage tank in fluid communication with the cleaning solution intake and a heating element for heating a cleaning solution. The storage tank includes a cleaning solution inlet, a pressure relief valve, an air pressure supply and a cleaning solution outlet. The cleaning system also includes an overflow tank, a service hose for directing heated cleaning solution to the diesel engine, and a vacuum gauge for monitoring engine vacuum pressure. The heated cleaning solution passes from the cleaning system to the diesel engine upon user activation via a control lever.

In an alternate embodiment of the present invention, a cleaning system comprises a cleaning solution intake, a storage tank, a supply conduit extending between the cleaning solution intake and the storage tank, a heating conduit extending from the storage tank and to a heating element, and an exit conduit extending from the heating element to a service hose. The storage tank comprises an inlet for receiving a cleaning solution, a pressure relief valve, a cleaning solution overflow conduit, and an outlet located opposite the inlet.

In yet another embodiment of the present invention, a method for removing deposits in a diesel engine comprises attaching a service adaptor coupled to a portable cleaning system to an air inlet portion of the diesel engine, operating the engine to achieve a normal operating temperature, filling the portable cleaning system with a predetermined amount of cleaning solution and applying pressurized air to the portable cleaning system. The cleaning solution is heated to a predetermined temperature and then a flow of cleaning solution is directed from the cleaning system into the air intake of the engine. The heated cleaning solution breaks down deposits as it passes through the engine. While the heated cleaning solution is being drawn into the engine, the cleaning system monitors the flow of the solution as well as engine output data to ensure proper functioning of the cooling cycle of the engine. Once a predetermined amount of cleaning solution has flowed into the engine, the engine is shut down and all service adaptors are removed.

Additional advantages and features of the present invention will be set forth in part in a description which follows, and in part will become apparent to those skilled in the art upon examination of the following, or may be learned from practice of the invention. The instant invention will now be described with particular reference to the accompanying drawings.

### BRIEF DESCRIPTION OF THE SEVERAL VIEWS OF THE DRAWINGS

The present invention is described in detail below with reference to the attached drawing figures, wherein:

FIG. 1 is a perspective view of a portable cleaning system in accordance with an embodiment of the present invention;

FIG. 2 is a perspective view of the portable system of FIG. 1 with a portion of a front cover cut-away to show internal components;

FIG. 3 is a rear perspective view of the portable system of FIG. 1;

FIG. 4 is a front elevation view of the portable system of FIG. 1 with a portion of the front cover cut-away to show internal components;

FIG. 5 is a schematic drawing of the portable cleaning system of FIG. 1;

FIG. 6 is a schematic drawing of the heating elements of the portable cleaning system of FIG. 1; and

FIG. 7 is a flow diagram disclosing a method of removing deposits in a diesel engine in accordance with an embodiment of the present invention.

### DETAILED DESCRIPTION

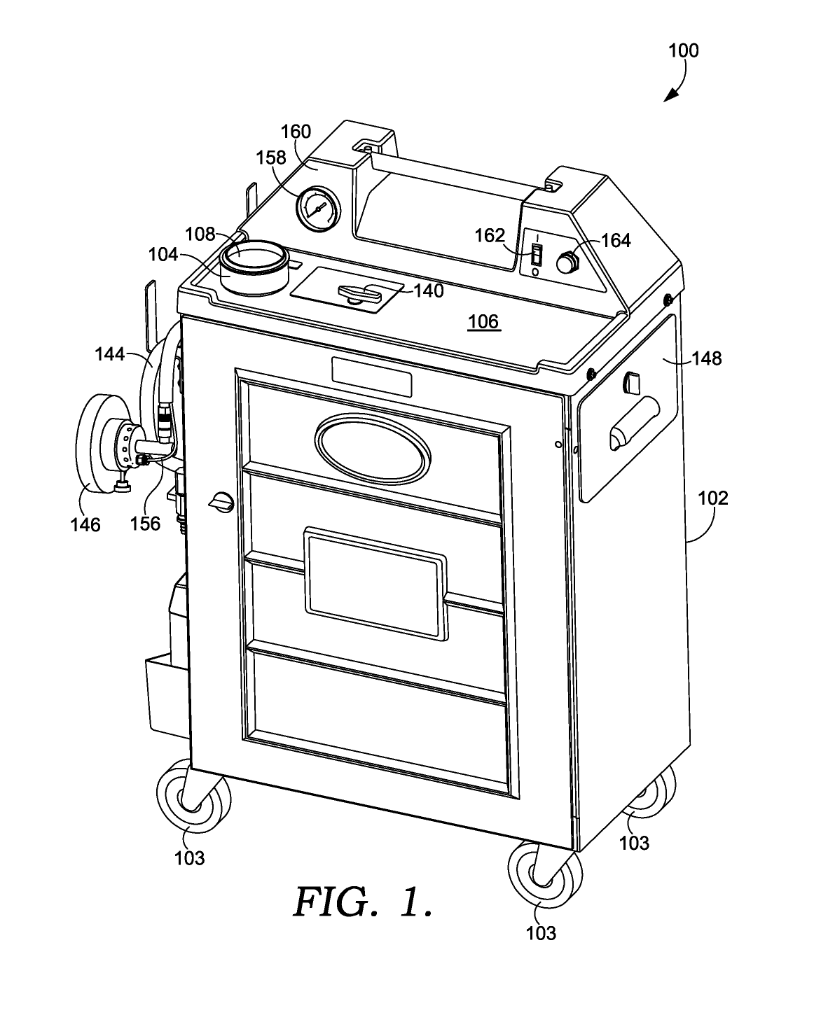

An embodiment of the present invention will now be described in detail with specific reference to FIGS. 1-7. Referring initially to FIG. 1, a portable cleaning system 100 for removing deposits, such as soot and oil residue, from a diesel engine is depicted. The portable cleaning system 100 is contained within a storage cart 102 that is movable to a variety of service locations by wheels or rollers 103. The storage cart 102 has a cleaning solution intake 104 extending through an opening in the storage cart 102. For the embodiment depicted in FIG. 1, the opening is located in a top portion 106 of the storage cart 102. The solution intake 104 can be in the form of a funnel or any other acceptable shape to hold the cleaning solution as the cleaning solution intake 104 forms a volume into which a predetermined amount of cleaning solution is poured prior to entering the cleaning system 100.

Prior to pouring a cleaning solution into the intake 104, or immediately thereafter, an intake cap 108 is placed over the intake 104 to ensure no dirt or debris or foreign fluid enters the cleaning system 100. The exact amount and type of cleaning solution to be used will vary depending on the size of diesel engine being cleaned by the portable cleaning system 100. For example, an acceptable type of cleaning solution is BG 258, a diesel induction system cleaning fluid, produced by BG Products, Inc. For a smaller diesel engine, such as that found in a passenger automobile, approximately one gallon of cleaning solution may be required to adequately clean the engine, whereas for diesel engines in larger cars or trucks, approximately 2-3 gallons of cleaning solution may be required to thoroughly flush and clean the engine of any deposits. As will be discussed in more detail below, the cleaning solution is injected into the air intake portion of the engine and is consumed during engine operation.

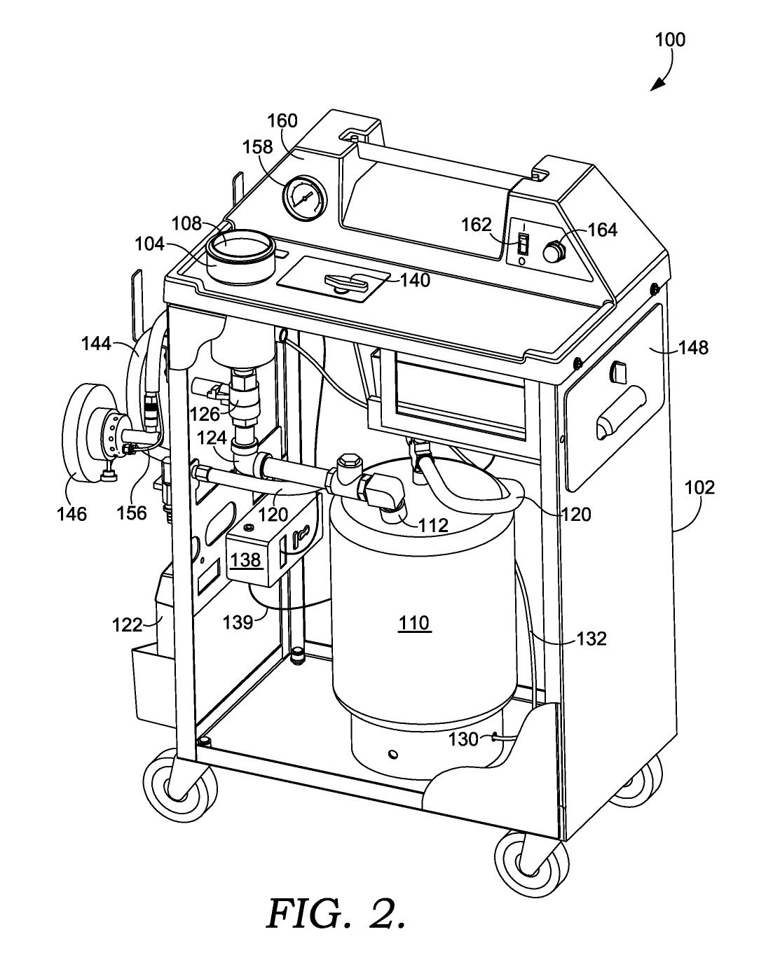

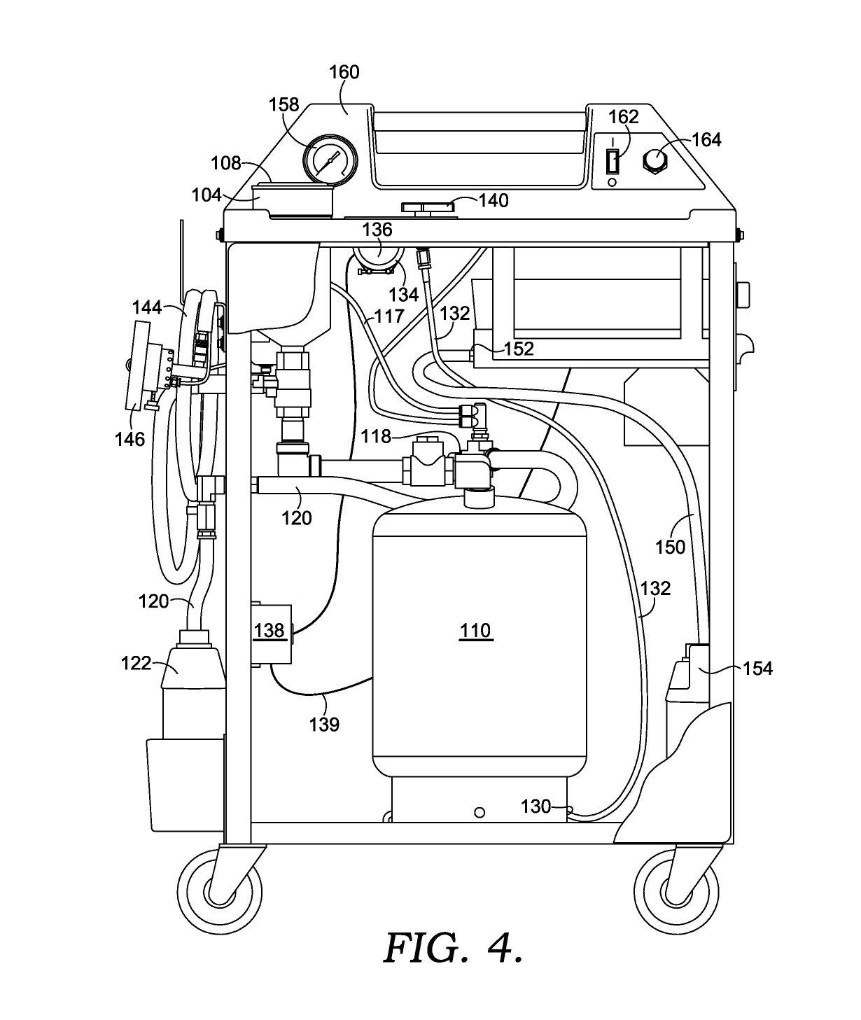

Additional details of the cleaning system can be seen in FIGS. 2 and 4, which have a portion of a front cover of the storage cart 102 cut away for clarity. Referring to FIGS. 2, 4 and 5, the portable cleaning system 100 also includes a storage tank 110 that is positioned within the storage cart 102 for storing a cleaning solution prior to use. The storage tank 110 is generally cylindrical in the embodiment depicted herein, but can take on a variety of shapes and sizes depending on the size and configuration of the storage cart 102. The storage tank 110 has a cleaning solution inlet 112 proximate a top portion of the storage tank 110 which is in selective fluid communication with the cleaning solution intake 104. The storage tank 110 also includes a pressure relief valve 114 for regulating the pressure within storage tank 110. The pressure relief valve 114 is controlled by pressure release button 164, as discussed below.

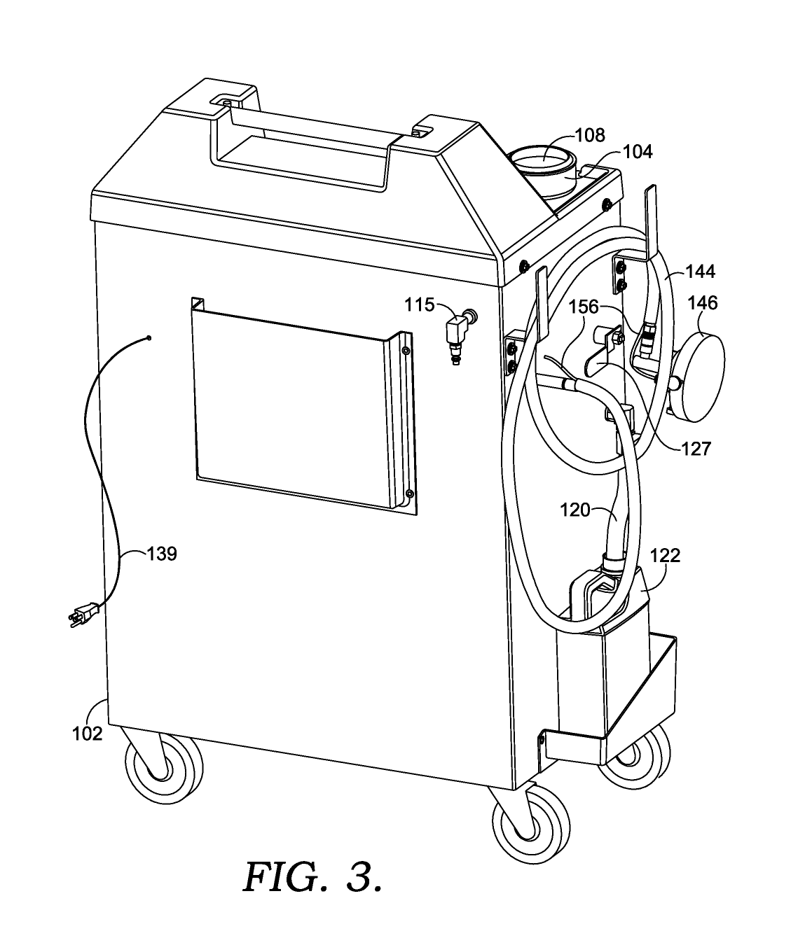

Referring to FIG. 3, a back view of the storage cart 102 is shown. The back portion of the storage cart 102 provides an air inlet port 115 for receiving a source of compressed air, such a shop air. As depicted in FIGS. 3-5, compressed air from an external pressurized source (such as an air compressor in the maintenance shop) is provided to the storage cart 102 at the inlet port 115 and through a pressure regulator 116, which is located at the back of storage cart 102, behind intake 104. Compressed air flows through an air pressure regulator 116 and an air inlet line 117 prior to flowing into the storage tank 110. The cleaning system 100 requires compressed air in order to maintain the storage tank 110 at a predetermined pressure so that the cleaning solution can be supplied to the diesel engine at a proper flow rate and pressure level. The pressure in the storage tank 110 is to be maintained at approximately 90 psi. The pressure relief valve 114 also includes a pop-off valve 118 that can be opened as necessary to relieve the pressure within the storage tank 110. Pressure within the storage tank can be regulated through a pressure release button 164, as will be discussed further below. Extending through a back portion of the storage cart 102 is a cord 139 for connection to an alternating current (AC) power supply. Cord 139 passes into the storage cart 102 and connects to a heater temperature control mechanism 138, as discussed below.

As it can be seen from FIGS. 2 and 4, the storage tank 110 also comprises a cleaning solution overflow conduit 120 which connects the storage tank 110 to an overflow tank 122. The overflow conduit 120 provides a way of collecting unused and excess cleaning solution should the storage tank 110 overflow with cleaning solution or be over-pressurized. The excess cleaning solution is directed to a location where the solution can be collected in a clean and easily accessible container for future use. In the embodiment depicted in FIGS. 2 and 4, the overflow tank 122 is positioned on the exterior of the storage cart 102, but the overflow tank 122 could also be positioned within the storage cart 102.

A supply conduit 124 extends between the cleaning solution intake 104 and the cleaning solution inlet 112. The supply conduit 124 also includes a valve 126, such as a ball valve, for regulating fluid flow between the cleaning solution intake 104 and the inlet 112 of the storage tank 110. The valve 126, and therefore the flow of cleaning solution from the solution intake 104 to the storage tank 110, is controlled by an access lever 127. For the embodiment of the present invention depicted herein, the access lever 127 is positioned on an exterior side of the storage cart 102. A check valve 128 is also positioned in the supply conduit 124 to ensure that the cleaning solution only flows in the direction towards the storage tank 110.

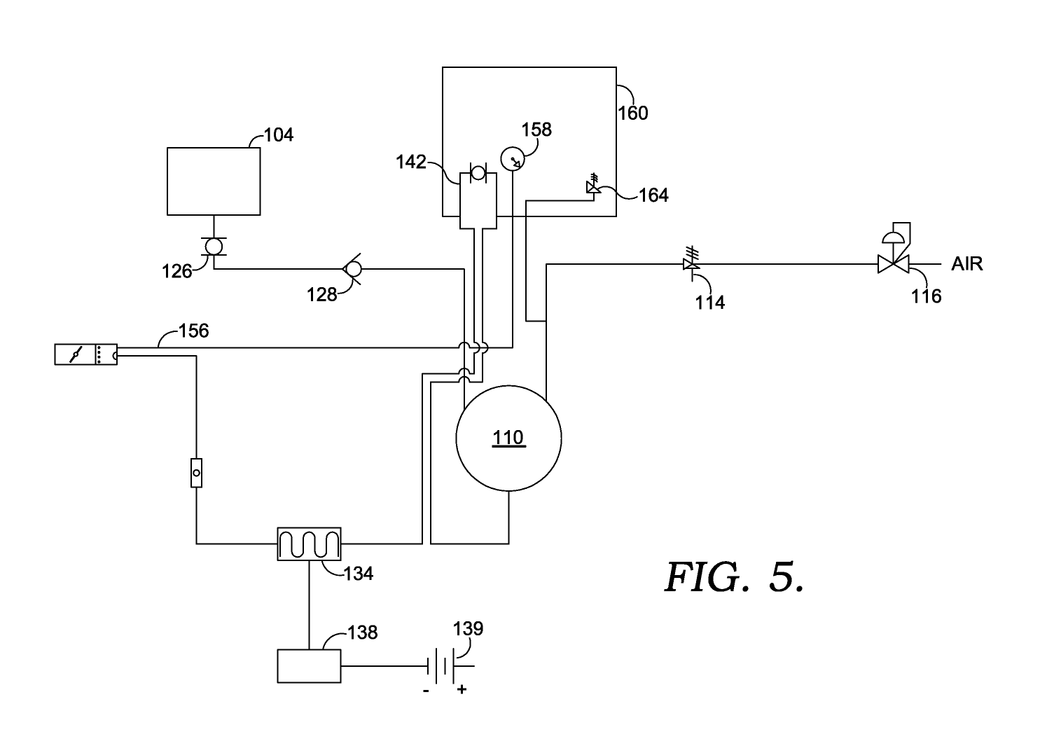

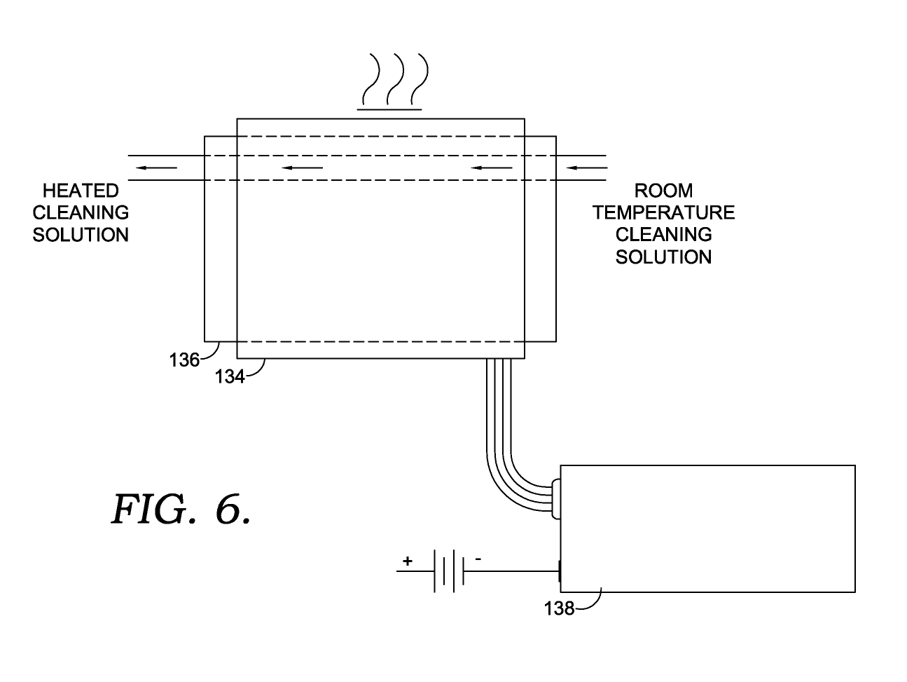

The storage tank 110 also comprises an outlet 130 positioned proximate a bottom portion of the storage tank 110, opposite the inlet 112. Coupled to the outlet 130 is an outlet supply line 132 which carries the cleaning solution from the storage tank 110 through the storage cart 102 to a heating element 134. The heating element 134, which is depicted schematically in FIGS. 5 and 6, comprises a thermal wrap that encompasses a cylindrical volume 136 through which the cleaning solution passes from outlet supply line 132. The cleaning solution enters the wrapped cylindrical volume at room temperature and the heating element 134 raises the temperature of the cleaning solution to approximately 140 degrees Fahrenheit prior to exiting the storage cart 102. The temperature of the heating element 134 is regulated by a heater temperature control mechanism or thermostat 138, which is electrically powered, preferably by an AC power supply through cord 139, as shown in FIGS. 2-4. The AC power supply cord 139 preferably extends through a back portion of the storage cart 102, but could also extend through side walls of the cart.

Referring to FIGS. 1, 2 and 4, the portable cleaning system 100 also comprises a control lever 140 for controlling the discharge of heated cleaning solution from the storage cart 102 and into the diesel engine of a vehicle being serviced. The control lever 140, when closed, keeps a ball valve 142 (FIG. 5) in a closed position and therefore prevents any cleaning solution from being heated and passed into the diesel engine being serviced. However, upon turning the lever 140, the ball valve 142 is placed in an open position, and cleaning solution is permitted to flow to the heating element 134 and from the cleaning system 100.

The portable cleaning system 100 also comprises a service hose 144 for directing heated cleaning solution from the storage cart 102 to the diesel engine being serviced. The service hose 144 is coupled to an adaptor 146, which is in turn, is coupled to an air inlet region of an engine to be cleaned (not depicted). The adaptor 146 can be a variety of sizes and shapes depending on the intake size and make of the engine being serviced. The storage cart 102 provides a hook or other means for storing the service hose 144 along a side of the storage cart.

The storage cart 102 also provides a slideable drawer or compartment 148 for storing additional equipment, such as adaptors 146, when not in use. Since the adaptor 146 or other equipment may have residual cleaning solution contained therein when it is placed in the compartment 148, the excess cleaning solution may leak out of the adaptor or other equipment. As such, the cleaning solution can collect in the compartment 148, which if left alone, can cause damage to the adaptors or other equipment stored in the compartment 148. To alleviate the collection of cleaning solution in compartment 148, a drain hose 150 is coupled to an outlet drain 152 in the compartment 148 and passes any cleaning solution or other dirt/debris from the compartment 148 to a drain tank 154. For the embodiment depicted in FIGS. 2 and 4, the drain tank 154 is located inside the storage cart 102. However, the drain tank 154 can be located external to the storage cart, similar to the overflow tank 122.

The service hose 144 also comprises a vacuum pressure line 156, which is coupled to a vacuum gauge 158 displayed on a control panel 160 as a dial indicator. Engine vacuum pressure is regulated by the intake adaptor 146 and engine speed (RPM) in order to control exhaust temperatures. The vacuum pressure line 156 reads the engine vacuum pressure of the engine in order to provide the service technician with a real-time measurement of the engine vacuum pressure for the operating conditions of the engine so that the technician can ensure cleaning solution is being drawn from the cleaning system 100 at the proper rate.

Referring to FIGS. 2, 4, and 5, the control panel 160 of the portable cleaning system 100 includes other means of controlling operation of the cleaning system 100. For example, the control panel 160 also includes a toggle power switch 162 for regulating power to the portable cleaning system 100 and a pressure release button 164 for activating the pressure release functions relating to the storage tank 110 discussed above.

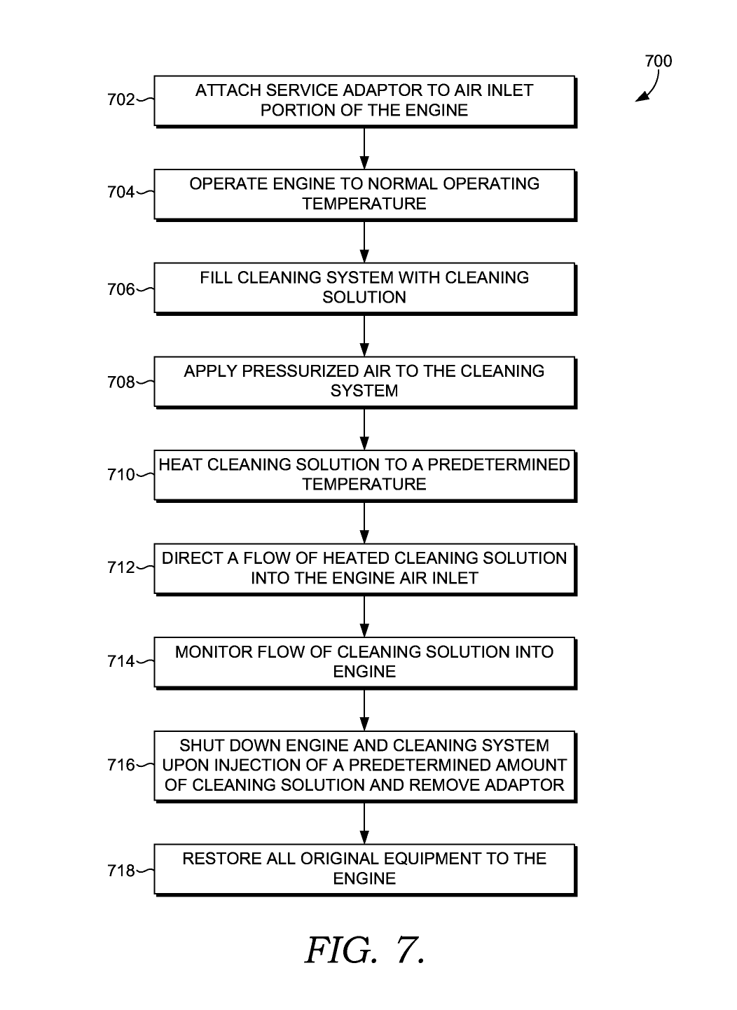

Referring now to FIG. 7, a method 700 of removing deposits from a diesel engine is disclosed. The method 700 includes attaching a service adaptor for a portable engine cleaning system to an air inlet portion of an engine in a step 702. The service technician should also ensure that the service adaptor is sealed to the engine intake. The exact size and configuration of the service adaptor will depend on the size and make of diesel engine being cleaned.

In a step 704, the diesel engine is then started and operated until a normal operating temperature is achieved. In addition, the service technician should ensure that the vacuum gauge of the cleaning system is operating and matches engine RPM. That is, for an embodiment of the present invention where the engine is operating at approximately 700 RPM, the vacuum pressure gauge should read approximately 7 in. Hg. During this engine start-up sequence, the engine speed is increased to approximately 1000 RPM such that exhaust gas temperatures reach and stabilize at approximately 650-750 deg. Fahrenheit. The specific target parameters can vary depending on the make and model of engine being serviced. Furthermore, while the method disclosed herein is based generally on engine speed and operating temperature, it is envisioned that the disclosed method could also be based on other engine parameters.

In a step 706, the portable cleaning system is filled with a cleaning solution as outlined above. Then, in a step 708, pressurized air is supplied to the portable cleaning system. Once the cleaning system is operational and the cleaning solution has been heated to a predetermined temperature in a step 710, then in a step 712, a flow of heated cleaning solution is directed from the portable cleaning system, through the service adaptor and into the air inlet portion of the diesel engine. The flow of the heated cleaning solution, status of the cleaning system and engine output data, such as vacuum pressure, are monitored in a step 714. The cleaning system will continue to operate and provide approximately one quart of cleaning solution to the diesel engine every fifteen minutes.

Upon complete injection of a predetermined amount of cleaning solution, the engine speed is lowered back to idle and the cleaning system and engine are shut down and the service adaptor removed in a step 716. In a step 718, all original equipment to the diesel engine removed for application of the cleaning solution is restored to its proper location.

While the invention has been described in what is known as presently an exemplary embodiment, it is to be understood that the invention is not to be limited to the disclosed embodiment but, on the contrary, is intended to cover various modifications and equivalent arrangements within the scope of the following claims. The present invention has been described in relation to particular embodiments, which are intended in all respects to be illustrative rather than restrictive. Alternative embodiments and required operations, will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

1. A portable cleaning system for removing deposits from a diesel engine comprising:
a storage cart;
a cleaning solution intake extending through an opening in the storage cart;
a storage tank coupled with the storage cart for storing a cleaning solution and having a cleaning solution inlet in selective fluid communication with the cleaning solution intake, a pressure relief valve, an air pressure regulator and a cleaning solution outlet;
a heating element coupled with the storage cart for heating the cleaning solution;
an overflow tank in fluid communication with the storage tank for capturing excess cleaning solution;
a service hose for directing heated cleaning solution from the storage cart to an adaptor coupleable to an air inlet region of the engine and for reading a vacuum pressure of the engine;
a vacuum gauge coupled with the storage cart for monitoring the vacuum pressure of the engine; and
a control lever in fluid communication with the service hose for controlling discharge of the heated cleaning solution to the air inlet region of the engine.

2. The portable cleaning system of claim 1, wherein the storage cart further comprises a slideable component drawer.

3. The portable cleaning system of claim 2, wherein the component drawer includes an outlet drain coupled to a drain tank for collecting any excess cleaning solution from components stored in the component drawer.

4. The portable cleaning system of claim 1 wherein the selective fluid communication between the cleaning solution intake and storage tank is controlled by an access valve accessible via a lever on an external surface of the storage cart.

5. The portable cleaning system of claim 1, wherein the overflow tank for capturing excess cleaning solution is located external to the storage cart.

6. The portable cleaning system of claim 1, wherein the heating element is positioned in fluid communication between the storage tank and the service hose.

7. The portable cleaning system of claim 1, wherein the cleaning solution passes from the intake to the storage tank and through a conduit to the heating element and then through the service hose where it enters the engine air inlet and is consumed during normal engine operation.

8. A method for removing deposits in a diesel engine comprising:
attaching a service adaptor of a portable cleaning system to an air inlet portion of the engine;
operating the engine to reach normal engine temperature;
filling the portable cleaning system with a cleaning solution;
applying pressurized air to the portable cleaning system;
heating the cleaning solution to a predetermined temperature;
directing a flow of heated cleaning solution from the portable cleaning system, through the service adaptor and into the air inlet portion of the engine;
monitoring the portable cleaning system, the flow of heated cleaning solution into the engine and engine output data to ensure proper function of a cooling cycle of the engine;
shutting the engine down upon injection of a predetermined amount of cleaning solution and removing the service adaptor of the portable cleaning system; and
restoring all original equipment to the engine.

9. The method of claim 9, wherein the step of filling the portable cleaning system with a cleaning solution comprises filling a cleaning solution intake with the cleaning solution and directing the cleaning solution to flow into a pressurizeable storage tank in the portable cleaning system.

10. The method of claim 9, wherein any excess cleaning solution not capable of being stored in the storage tank, passes from the storage tank and into an overflow tank

11. The method of claim 9, wherein the cleaning solution passes from the cleaning solution intake to the storage tank by opening an access valve and wherein the access valve is controlled by an lever positioned on an external surface of the portable cleaning system.

12. The method of claim 8, wherein the cleaning solution is heated by a heating element positioned within the portable cleaning system.

13. The method of claim 11, wherein the cleaning solution is heated to approximately 140 deg. F.

14. The method of claim 8, wherein the cleaning solution is consumed during engine operation.

15. A cleaning system for removing deposits form a diesel engine comprising:
a cleaning solution intake;
a storage tank coupled with the cleaning solution intake and comprising:
an inlet for receiving a cleaning solution from the cleaning solution intake located proximate a top portion of the storage tank;
a pressure relief valve and a cleaning solution overflow conduit coupled to a top portion of the storage tank; and
an outlet located proximate a bottom portion of the storage tank;
a supply conduit extending between the cleaning solution intake and the inlet of the storage tank and having a valve for regulating fluid flow between the cleaning solution intake and the inlet of the storage tank;
a heating conduit extending from the outlet of the storage tank to a heating element; and
an exit conduit extending from the heating element to a service hose.

16. The cleaning system of claim 15, wherein the valve in the supply conduit comprises a ball valve controllable by a lever positioned external to the cleaning system.

17. The cleaning system of claim 15, wherein the storage tank is maintained at a predetermined pressure through an external compressed air supply source.

18. The cleaning system of claim 15, supported upon a portable storage cart.

19. The cleaning system of claim 15, wherein the heating element is a wrap extending about a cylindrical container in order to raise the temperature of a portion of the cleaning solution.

20. The cleaning system of claim 15, wherein the supply conduit further comprises a check valve to ensure no cleaning solution passes from the storage tank upstream and into the cleaning solution intake.
